(19) United States
(12) Patent Application Publication
(10) Pub. No.: US 2005/0263100 A1
(43) Pub. Date: Dec. 1, 2005

(54) Collarless pet containment system

(76) Inventors: Joseph Kover JR., Layton, UT (US); Scott L. Maxfield, Hooper, UT (US); Robert Ned Silvester, North Logan, UT (US)

Correspondence Address: Joseph Kover, Jr., 974 North Aspen Way, Layton, UT, 84040, US

(21) Appl. No.: 10/857,159

(22) Filed: Jun. 1, 2004

(51) Int. Cl. A01K 15/02

(52) U.S. Cl. 119/721

(57) ABSTRACT

The invention relates to a domesticated collarless pet or pets containment system comprised of a series of detection sensors that serve to establish a boundary, a control means which serves to monitor the detection sensors and should a pet or pets advance beyond the established boundary the control means would activate the perceptive sanctioning means, whereby the perceptive sanctioning means may essentially be comprised of water, however the sanctioning means is environmentally friendly and harmless to all life forms. The sanctioning means could further include an audio means whereby the audio means is activated in conjunction with the perceptive sanctioning means. It may, however, be desirable to deactivate the audio sanctioning means during the hours of darkness. However, careful consideration should be given to local noise ordnances.

### BACKGROUND OF THE INVENTION

The present invention relates to a domesticated collarless pet or pets containment system whereby the collarless containment system limits the movement of a domesticated pet or pets to within an established boundary so as to protect the pet or pets from the unknown dangers that lie beyond these established boundaries.

The concept to limit the movement of a domesticated pet or pets, to an established boundary, has revealed a variety of domesticated pet or pets containment systems. Boardman submits a wireless pet containment system (U.S. Pat. No. 5,381,129 and U.S. Pat. No. 5,852,403 issued to Allen H. Boardman in January 1995 and December 1998), while a second system submits a device for prohibiting the crossing of a zone boundary by an animal (U.S. Pat. No. 6,158,392 issued to Max Andre and Xavier Aubry in December 2000). A third system submits a wireless confinement and training system for an animal (U.S. Pat. No. 6,431,122 B1 issued to Michael D. Westrick, Scott E. Maddox, and Peter F. Johnson in August 2002), while a fourth system submits an apparatus and method for electronic exclusion and confinement of animals relative to a selected area (U.S. Pat. No. 6,657,544 B2 issued to James R. Barry, John S. Titus, and Dennis L. Larson in December 2003). A fifth system submits an animal control system (U.S. Pat. No. 6,684,820 B1 issued to James E. Davis in February 2004), while a sixth system submits a satellite animal containment system with programmable boundaries (U.S. Pat. No. 6,700,492 issued to Scott F Touchton, Richard D. Mellinger, and Donald L Pinetti in March 2004).

The first common disadvantage of all six systems is that every pet that is to be contained within an established boundary or excluded from an area is required to wear a collar whereby a transmitter and/or a receiver device is fastened onto the collar. The disadvantage of this concept is that the weight and the bulk of the transmitter and/or receiver collar causes considerable discomfort to the small pet population including the feline pet population. A second disadvantage is that the transmitter and/or receiver devices that are fastened onto the collars require an electrical power source by means of a battery, whereby a discharged battery would neutralize the system. A third disadvantage, of these collars, is that they become financially prohibitive when several pets are to be contained within an established boundary or excluded from an area, since each pet is required to wear a collar

An additional disadvantage of all six systems is that all six systems require a transmitter and/or receiver station in conjunction with the transmitter and/or receiver collar. The transmitter and/or receiver station serves to monitor the position of the pet or pets and should the movement of the pet or pets exceed the established boundaries then the sanctioning means is activated. The transmitter and/or receiver stations also require an electrical power source either by means of a battery or local alternating current. Again a discharged battery or a power outage would neutralize these systems. Furthermore, natural events or events produced by man could disrupt the communications between the transmitter and/or receiver station and the transmitter and/or receiver collar and therefore neutralize these systems.

A third disadvantage of these systems, with the exception of U.S. Pat. No. 6,158,392 issued to Max Andre and Xavier Aubry in December 2000, is that the sanctioning means, when the pet or pets exceed the established boundary, is comprised of an electrical shock. One disadvantage of electrical shock sanctioning is that it is considered cruel and inhumane by several humane organizations. A second disadvantage of electrical shock sanctioning is that it may serve to confuse and/or frighten the pet or pets or it may be mistaken for an insect bite. In either case electrical shock sanctioning may cause the pet or pets to flee further away from the established boundary. The exception to the electrical shock sanctioning means is U.S. Pat. No. 6,158,392 issued to Max Andre and Xavier Aubry in December 2000. The sanctioning means of this system is comprised of a fogging fluid that is emitted from a reservoir that is fastened onto the collar in conjunction with the transmitter and/or receiver device. Again, as with the administration of an electrical shock, the administration of a fogging fluid, though not considered as cruel and inhumane, may only serve to confuse and/or frighten the pet or pets or have an insignificant effect on the pet or pets.

A fourth disadvantage of these systems is that the sanctioning means is solely comprised of an imperceptible source. Therefore, these systems would be ineffective in limiting the movements of the feline pet or pets. A sanctioning means that is humane and offers a visible deterrent would serve as a more effective means to limit the movement of both the canine and the feline pet or pets to within an established boundary. The technology of those systems to limit the movement of a domesticated pet or pets, to an established boundary, has offered very little innovation since their introduction, in terms of detection means and sanctioning means. The implementation of the detection means remains by means of a transmitter device and a receiver device. Furthermore, the pet or pets are required to wear a collar, while the sanctioning means, with one exception, when the pet or pets exceed the established boundary remains by means of an electrical shock.

### SUMMARY OF THE INVENTION

The present invention relates to a domesticated collarless pet or pets containment system, which resolves those limitations that exist in the prior art. The invention reveals a detection means that eliminates the transmitter/receiver collar, the transmitter/receiver station, and the issue of discharged batteries. The invention further reveals a sanctioning means which eliminates the current inhumane and imperceptible sanctioning means.

The preferred embodiment of a domesticated collarless pet or pets containment system is comprised of a series of motion sensors or a series of beam sensors that serve to establish a boundary. The control means serves to monitor the motion sensors or the beam sensors and should a pet or pets advance beyond the established boundary the control means would activate an electrically controlled valve. The electrically controlled valve serves to dispense the liquid to the sanctioning means, whereby the liquid sanctioning may essentially be comprised of water, however is environmentally friendly and harmless to all life forms. The sanctioning means could further include an audio means whereby the audio means is activated in conjunction with the liquid sanctioning means. It may, however, be desirable to deactivate, either by manual or automatic means, the audio sanctioning means during the hours of darkness. However, careful consideration should be given to local noise ordnances. The sanctioning means serves to form a barrier by means of a series of liquid showers, which in turn, forces the pet or pets to return to within the established boundary. Once the pet or pets have returned to the established boundary the sanctioning means will remain activated for a predetermined time so as to reinforce the established boundary. However, should the pet or pets remain in the established boundary, the sanctioning means will remain in an active state. The liquid sanctioning means offers a sanctioning means that is humane, that is perceptible, and that is effective on all pets including the feline pet or pets.

The series of motion sensors or the series of beam sensors would eliminate the transmitter/receiver collar and therefore would become feasible for a small pet or pets to include a feline pet or pets. Furthermore, the pet containment system control means, to eliminate the possibility of a discharged battery, integrates photovoltaic technology in conjunction with a battery as the electrical power source, whereby during the hours of daylight the photovoltaic panel would serve a dual purpose. First, the photovoltaic panel would serve as the electrical power source for the control means. Second, the photovoltaic panel would serve to charge the battery whereby the battery serves as the electrical power source for the control means during the hours of darkness. The benefit of the implementation of the electrical power source for the control means by means of photovoltaic technology is that this would allow facilitate the electrical power source to support the control means for several years.

### BRIEF DESCRIPTION OF THE DRAWINGS

FIGS. 1, 2, and 3 illustrates the application of the system, according to the various embodiments of the present invention, to include the detection means, the control means, and the liquid sanctioning means, whereby exemplary situations are revealed.

FIGS. 4, 5, and 6 are schematic diagrams, according to the present invention, that illustrates the electrical power source, the detection means, the processing means, and the circuit for the control of the electrical valve, and the liquid sanctioning means.

FIG. 7 is the circuit diagram, according to the various embodiments of the invention, which illustrates an exemplary liquid solution storage means, for sanctioning, when the temperature falls below freezing.

FIG. 8 is the general flow chart, according to the invention, that illustrates the program logic of the control means.

### DETAILED DESCRIPTION OF THE PREFERRED EMBODIMENTS

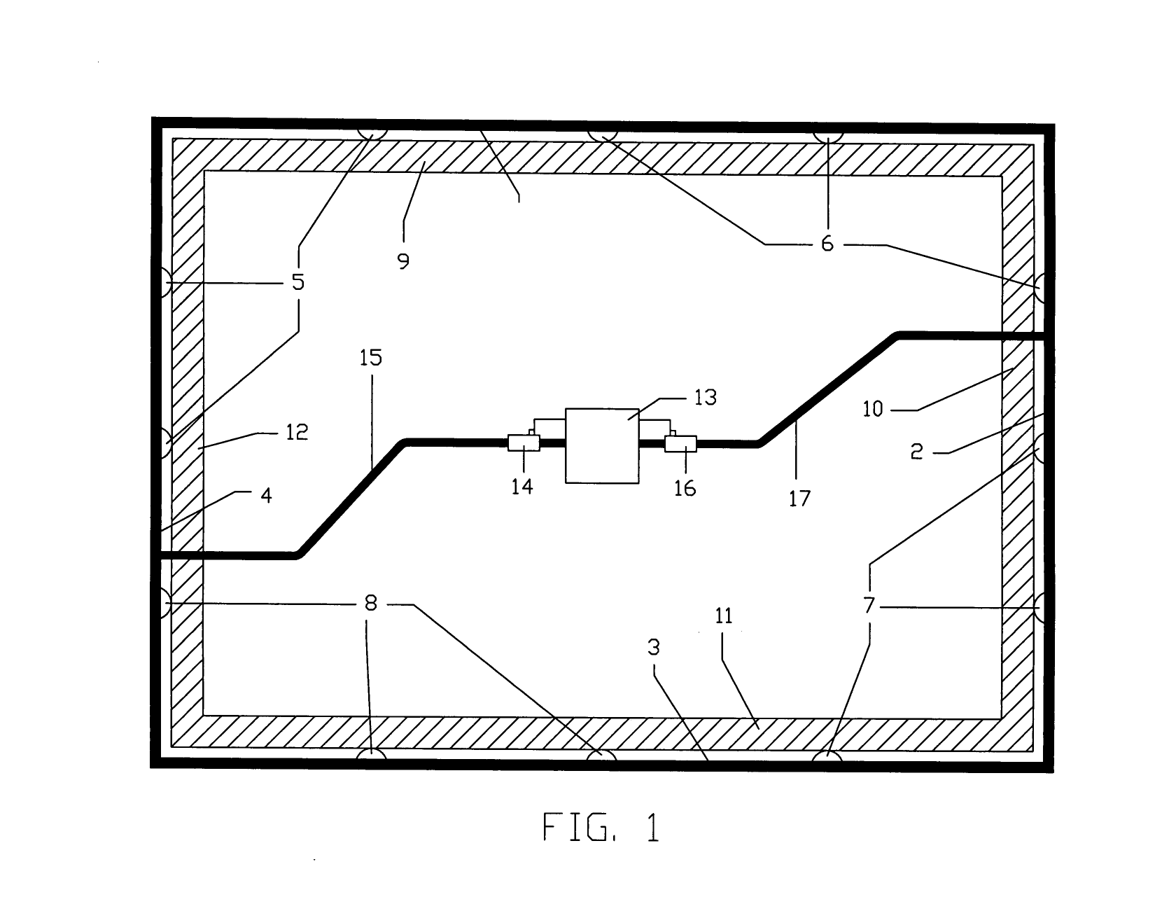

The drawing shown in FIGS. 1, 2, 3, 4, 5, 6, 7, and 8 for the preferred embodiments of a collarless pet containment system will now be addressed in complete detail.

FIG. 1 reveals the embodiment according to the invention of a collarless pet containment system to include the detection means comprised of a series of motion sensors 5, 6, 7, and 8 and the established boundary 9, 10, 11, and 12. FIG. 1 further reveals the control means 13, the electrical control valves 14 and 16, and the liquid sanctioning means 1, 2, 3, 4, 15, and 17, whereby, the liquid sanctioning means 1, 2, 3, and 4, which is environmentally friendly and harmless to all life forms, encompasses the established boundary and forms a barrier by means of a series of liquid showers.

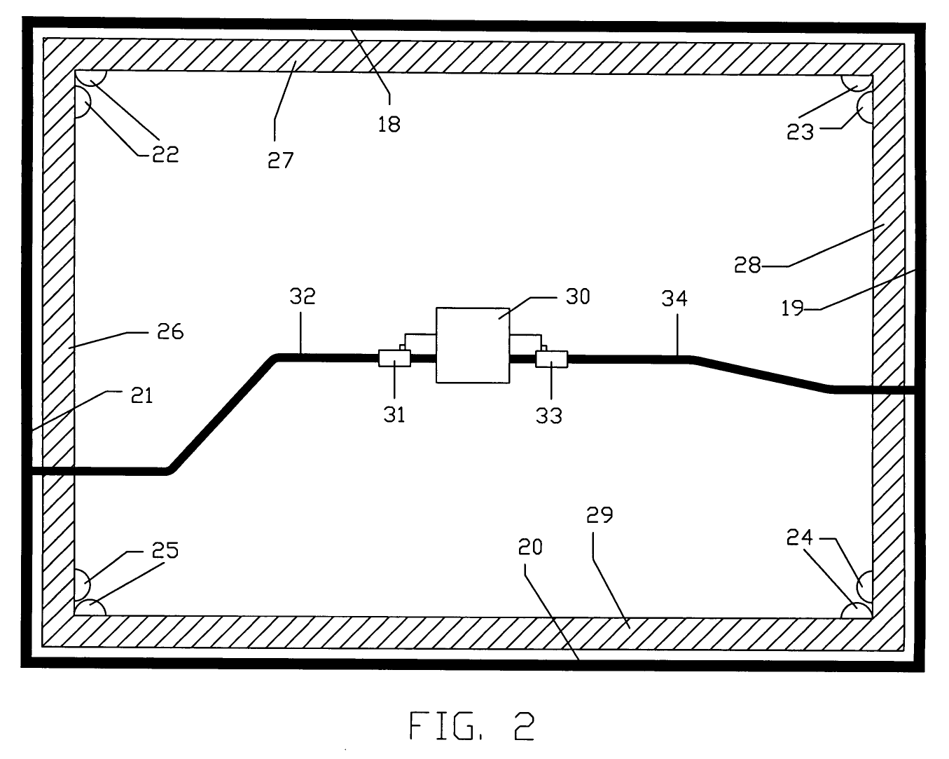

FIG. 2 reveals the embodiment according to the invention of a collarless pet containment system to include the detection means comprised of a series of beam sensors 22, 23, 24, and 25 and the established boundary 26, 27, 28, and 29. FIG. 2 further reveals the control means 30, the electrical control valves 31 and 33, and the liquid sanctioning means 18, 19, 20, 21, 32, and 34, whereby, the liquid sanctioning means 18, 19, 20, and 21, is environmentally friendly and harmless to all life forms, encompasses the established boundary and forms a barrier by means of a series of liquid showers.

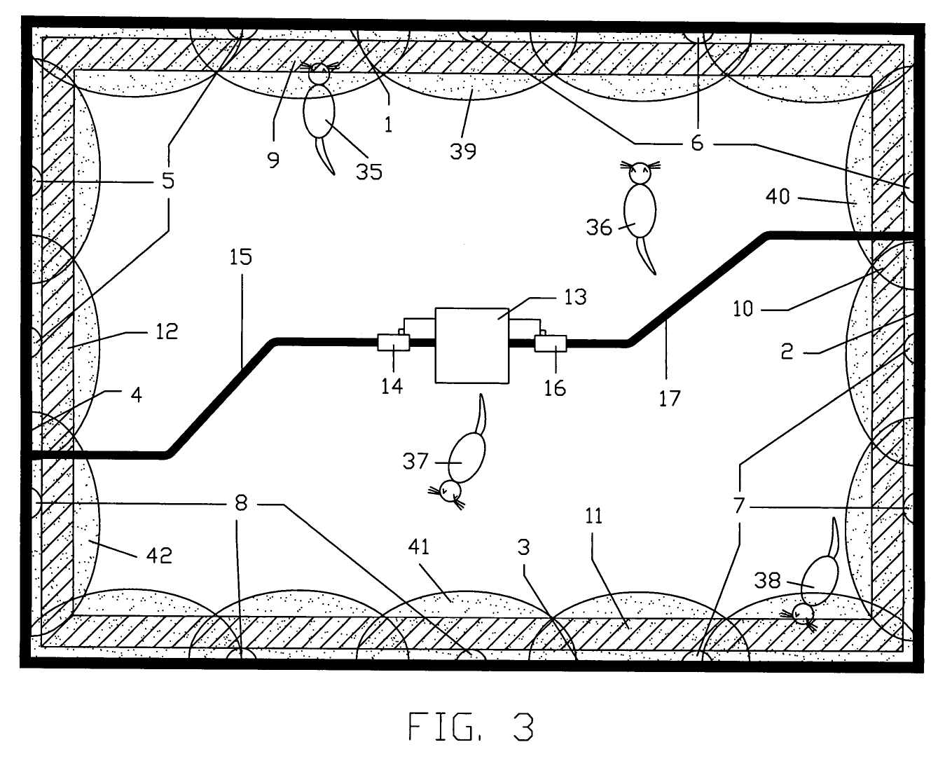

FIG. 3 reveals the functional embodiment according to the invention of a collarless pet containment system to include the detection means comprised of a series of motion sensors 5, 6, 7, and 8 and the established boundary 9, 10, 11, and 12. FIG. 3 further reveals the control means 13, the electrical control valves 14 and 16, and the liquid sanctioning means 1, 2, 3, 4, 15, and 17, whereby, the liquid sanctioning means 1, 2, 3, and 4, which is environmentally friendly and harmless to all life forms, encompasses the established boundary and forms a barrier by means of a series of liquid showers. In addition the functional embodiment reveals two pets within the established boundary 36 and 37, two pets beyond the established boundary 35 and 38, and the barrier that is formed by means of a series of liquid showers 39, 40, 41, and 42. The detection means comprised of a series of motion sensors 5, 6, 7, and 8 has detected two pets 35 and 38 beyond the established boundaries 9 and 11. The control means then activates the sanction means which forms a barrier by means of a series of liquid showers 39, 40, 41, and 42, which in turn, forces the pets 35 and 38 to return within the established boundary 9, 10, 11, and 12. Once the pets 35 and 38 have returned to within the established boundary 9, 10, 11, and 12 the sanctioning means will remain activated for a predetermined time so as to reinforce the established boundary. However, should either pets 35 and 38 remain beyond the established boundaries 9 and 11 or should any of the pets 35, 36, 37, or 38 advance beyond the established boundaries 9, 10, 11, or 12 the sanctioning means will remain in the active state. The sanctioning means could further include an audio means whereby the audio means is activated in conjunction with the liquid sanctioning means. It may, however, be desirable to deactivate, either by manual or automatic means, the audio sanctioning means during the hours of darkness. However, careful consideration should be given to local noise ordnances.

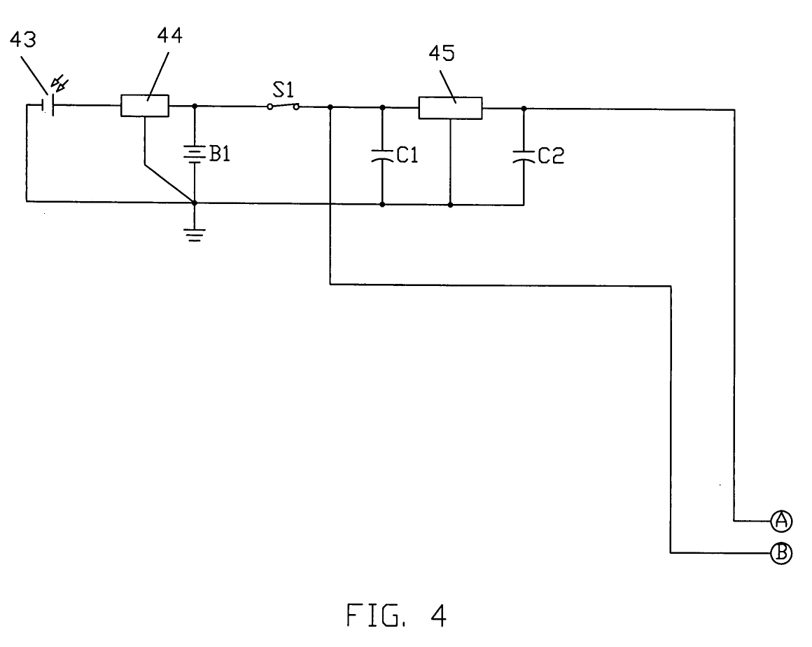

FIG. 4 is the first schematic diagram, according to the present invention, that illustrates the photovoltaic panel 43, the battery charger 44, the battery B1, which supplies current to the control means during the hours of darkness, the switch S1 to deactivate the collarless pet containment system, the voltage regulator 45 and the corresponding filter capacitors C1 and C2, and the output terminals A and B. The photovoltaic panel 43, during the hours of daylight, supplies current to the battery charger 44, that recharges battery B1, to the voltage regulator 45 by means of S1, and to output terminal B, while the voltage regulator 45 supplies current to the output terminal A.

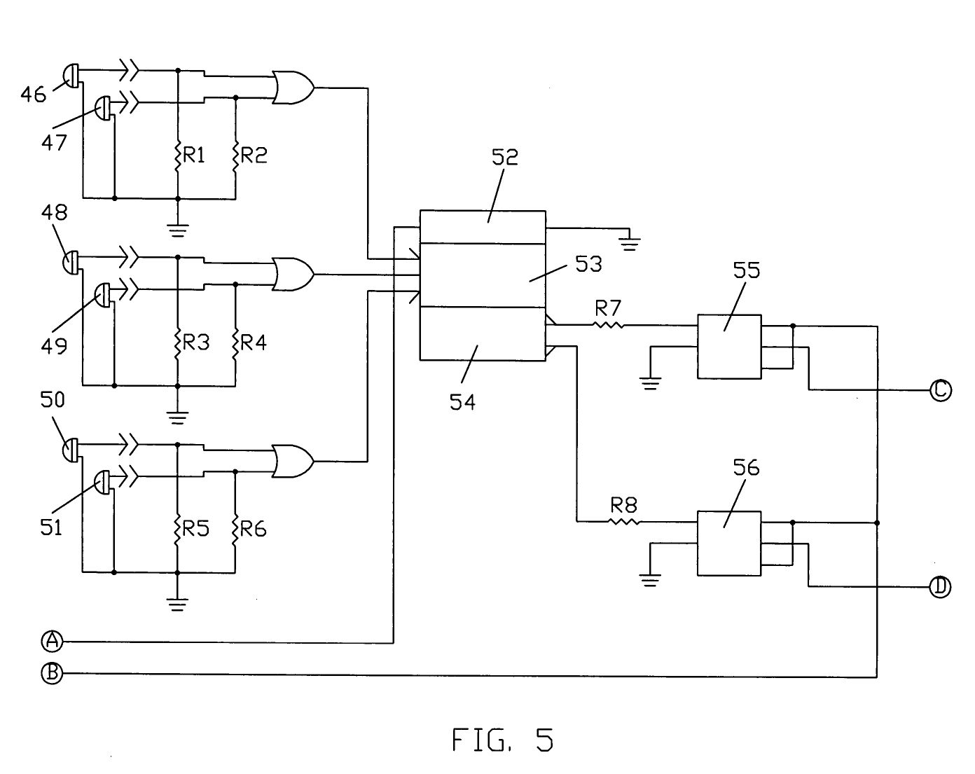

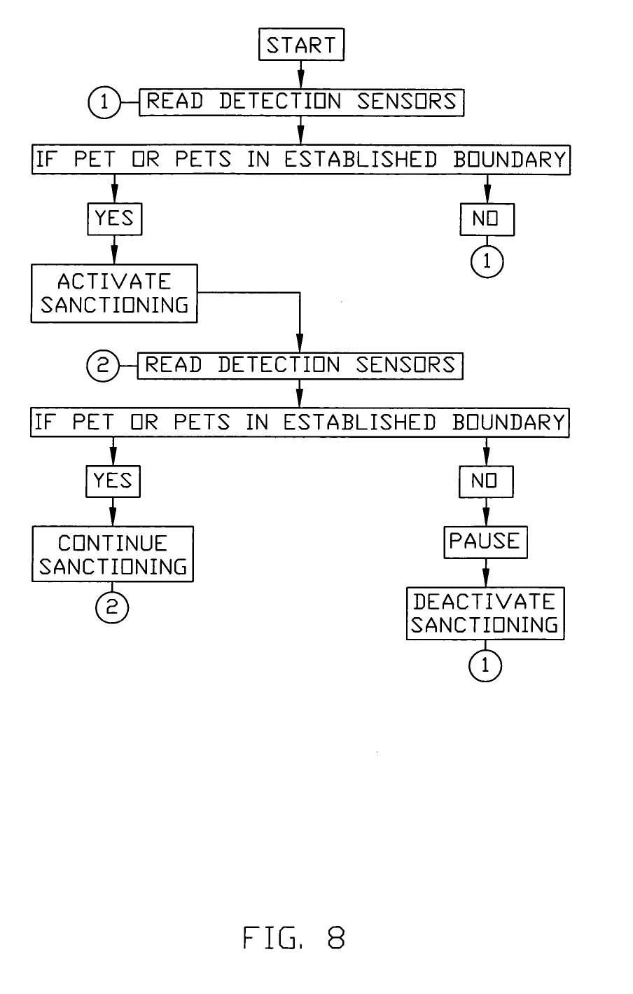

FIG. 5 is the second schematic diagram, according to the present invention, that illustrates the motion sensors 46, 47, 48, 49, 50, and 51, the OR gates and the corresponding pull down resistors R1, R2, R3, R4, R5, and R6, the microcontroller unit 52 that includes onboard RAM, onboard ROM, where the control program of FIG. 8 permanently resides, an onboard input port 53, and an onboard output port 54. FIG. 5 further reveals the optically coupled solid state relays 55 and 56, the corresponding current limiting resistors R7 and R8, and the input terminals A and B from the corresponding output terminals A and B of FIG. 4, and the output terminals C and D. Input terminal A supplies approximately 5 volts from the voltage regulator 45 of FIG. 4, to the microcontroller 52, the OR gates, and the motion sensors 46, 47, 48, 49, 50, and 51, while input terminal B supplies approximately 12 volts to the optically coupled solid state relays 55 and 56. If the pet or pets should advance beyond the established boundary a logical high would be realized on the input of the OR gate and/or OR gates from the motion sensor and/or motion sensors 46, 47, 48, 49, 50, and 51. A logical high on any input of the OR gate and/or OR gates would produce a corresponding logical high on the output of the OR gate and/or OR gates, which in turn would produce a logical high at the input port of the microcontroller. The logical high that is realized on the input port of the microcontroller would produce a corresponding logical low on the optically coupled solid state relays 55 and 56 which would produce zero volts at the output terminals C and D. However, should the pet or pets remain within the established boundary logical lows would be realized on the inputs of the OR gates from the motion sensors 46, 47, 48, 49, 50, and 51. Logical lows on the inputs of the OR gates would produce corresponding logical lows on the outputs of the OR gates, which in turn would produce logical lows at the input port of the microcontroller. The logical lows that are realized on the input port of the microcontroller would produce a corresponding logical highs on the optically coupled solid state relays 55 and 56 which would produce twelve volts at the output terminals C and D.

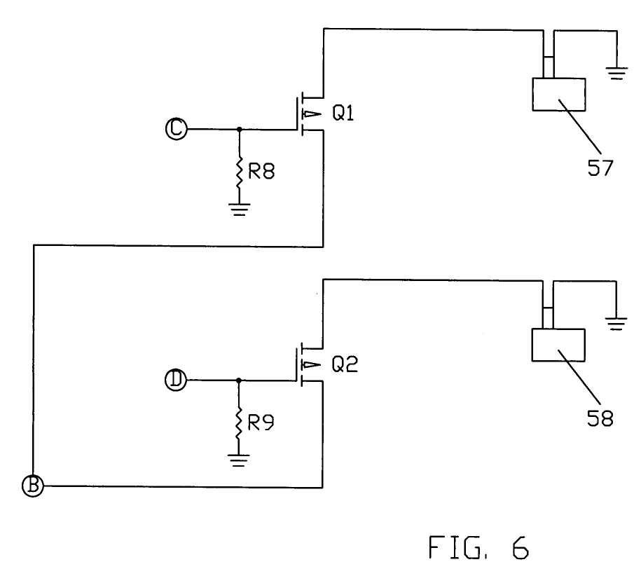

FIG. 6 is the third schematic diagram, according to the present invention, that illustrates the electrical valve control transistors Q1 and Q2, the corresponding pull down resistors R8 and R9, and the electrical control valves 57 and 58. FIG. 6 further illustrates the input terminals B, C, and D from the corresponding output terminals B of FIG. 4, C, and D of FIG. 5. The voltage from input terminals C and D to the gates of the electrical valve control transistors Q1 and Q2 serve to activate and deactivate the sanctioning means. Whereby, with zero volts applied to the gate of an electrical valve control transistor the sanctioning means would be in the active state and with twelve volts applied to the gate of an electrical control transistor the sanctioning means would be in the inactive state.

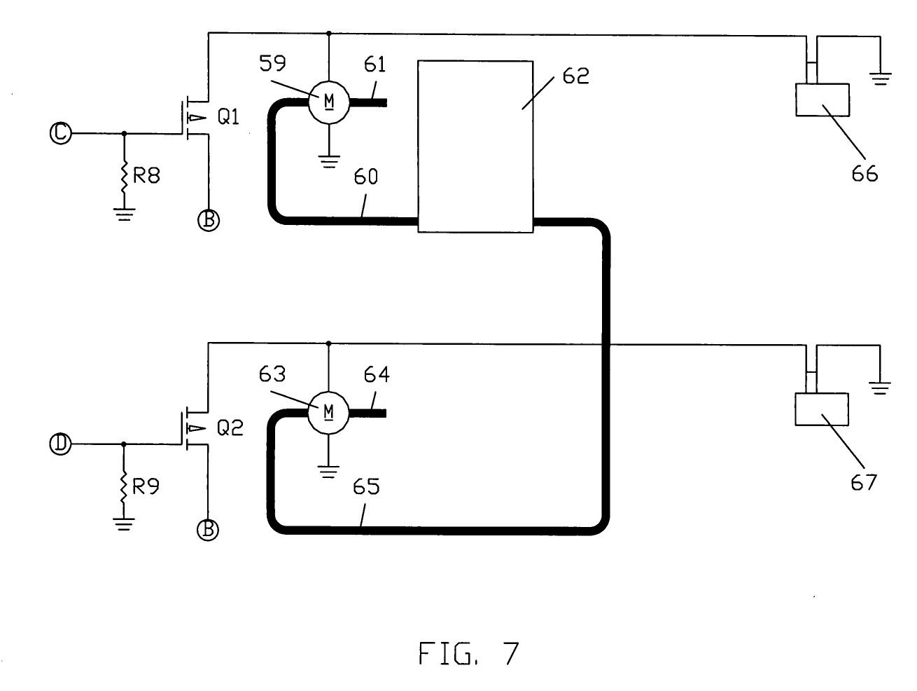

FIG. 7 reveals the embodiment according to the invention of a collarless pet containment system to include a reservoir 62, which contains an environmentally friendly and harmless to all life forms liquid solution for when the temperature falls below freezing. FIG. 7 further reveals the pumps 59 and 63, the liquid sanctioning means 60, 61, 64, and 65, and the electrically controlled valves 66 and 67. If a pet or pets should advance beyond the established boundary the control means would activate pumps 59 and 63 and the electrically controlled valves 66 and 67. The pumps 59 and 63 in conjunction with the electrically controlled valves 66 and 67 serve to dispense the liquid to the sanctioning means. The sanctioning means serves to form a barrier by means of a series of liquid showers, which in turn, force the pet or pets to return to within the established boundary. Once the pet or pets have returned to the established boundary the sanctioning means will remain activated for a predetermined time so as to reinforce the established boundary. However, should the pet or pets remain in the established boundary, the sanctioning means will remain in an active state. The sanctioning means could further include an audio means whereby the audio means is activated in conjunction with the liquid sanctioning means. It may, however, be desirable to deactivate, either by manual or automatic means, the audio sanctioning means during the hours of darkness. However, careful consideration should be given to local noise ordnances.

FIG. 8 is the general flow chart, according to the invention, that illustrates the program logic, which resides in the microcontroller ROM, of the control means. In the first step, the detection sensors are read and if a pet or pets are detected beyond the established boundary then the sanctioning means are activated. In the second step the detection sensors are again read and if the pet or pets remain beyond the established boundary the sanctioning means remains activated. However, if the pet or pets have returned to within the established boundary the sanctioning means will remain in the active state for a predetermined time to reinforce the established boundary and the program returns to the first step whereby the detection sensors are read. In the first step, however, should the pet or pets remain within the established boundary the sanctioning means remains in the inactive state and the program returns to the first step whereby the detection sensor are read.

It is understood that FIGS. 4 through 6 illustrate the implementation of the invention is realized by digital logic and microcontroller means, however the implementation of the invention could also be realized by analog means. It is further understood that the invention reveals a perceptible sanctioning means by means of a liquid, however the implementation of the sanctioning means may include any perceptible sanctioning means.

1. A collarless pet containment system to limit the movement of a domesticated pet or pets to within an established boundary comprising:
an electrical power source;
a sensing means to reveal that a pet or pets has advanced beyond an established boundary;
a control means to monitor the sensing means and to activate and deactivate the sanctioning means;
a perceptible sanctioning means.

2. The collarless pet containment system, according to claim 1, whereby the electrical power source is implemented by means of a photovoltaic panel or panels and a battery, whereby during the hours of daylight the photovoltaic panel or panels serve as the electrical power source for the control means and recharge the battery which serves as the electrical power source for the control means during the hours of darkness.

3. The collarless pet containment system, according to claim 1, whereby the sensing means is implemented such as to comprise an established boundary.

4. The collarless pet containment system, according to claim 1, whereby the perceptible sanctioning means forms a barrier which precludes a pet or pets from progressing beyond an established boundary.

5. A collarless pet containment system to limit the movement of a domesticated pet or pets to within an established boundary comprising:
an electrical power source;
a sensing means to reveal that a pet or pets has advanced beyond an established boundary;
a control means to monitor the sensing means and to activate and deactivate the sanctioning means;
a perceptible and an audio sanctioning means.

6. The collarless pet containment system, according to claim 1, whereby the electrical power source is implemented by means of a photovoltaic panel or panels and a battery, whereby during the hours of daylight the photovoltaic panel or panels serve as the electrical power source for the control means and recharge the battery which serves as the electrical power source for the control means during the hours of darkness.

7. The collarless pet containment system, according to claim 5, whereby the sensing means is implemented such as to comprise an established boundary.

8. The collarless pet containment system, according to claim 5, whereby a perceptible and an audio sanctioning means forms a barrier which precludes a pet or pets from progressing beyond an established boundary.
